(19) United States
(12) Patent Application Publication
(10) Pub. No.: US 2026/0316791 A1
(43) Pub. Date: Oct. 15, 2026

(54) SYSTEM AND METHOD FOR ENVIRONMENTAL MODIFICATION OF OPERATING BEHAVIORS FOR AN AUTONOMOUS VEHICLE

(71) Applicant: Torc Robotics, Inc., Blacksburg, VA (US)

(72) Inventors: Akshay Pai Raikar, Austin, TX (US); Garrett Madsen, Austin, TX (US); Michael Avitabile, Austin, TX (US); William Gray Davis, Austin, TX (US); Joseph R. Fox-Rabinovitz, Austin, TX (US)

(21) Appl. No.: 19/174,472

(22) Filed: Apr. 9, 2025

(51) Int. Cl. B60W 60/00; G06F 16/29

(52) U.S. Cl. CPC B60W 60/00182; G06F 16/29; B60W 2555/20; B60W 2556/50

(57) ABSTRACT

A system for environmental modification of operating behaviors for an autonomous vehicle is described. The system includes a database configured to electronically store a plurality of geographic operation profiles and a processing device in communication with the database. The processing device is configured to execute instructions stored in a memory to perform operations. The operations include receiving location data for the autonomous vehicle, selecting at least one applicable geographic operation profile from the plurality of geographic operation profiles based on the location data, and modifying an operating protocol for the autonomous vehicle based on the at least one applicable geographic operation profile, wherein the operation of the autonomous vehicle is aligned with the modified operating protocol.

### TECHNICAL FIELD

The field of the disclosure relates to environmental modification of operating behaviors for an autonomous vehicle and, in particular, to a system and method for environmental modification of operating behaviors for an autonomous vehicle to allow the operation of the autonomous vehicle to better conform to geographic vehicle operating norms using geographic operation profiles.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

In operation, these autonomous vehicles travel though many different geographic locations. In some cases, drivers in certain geographic locations may have different operating norms from drivers in different other geographic locations. For example, drivers in environments with a high volume of traffic may drive more aggressively and create a greater risk to other vehicles travelling in the same high traffic environment than drivers travelling in environments with a low volume of traffic. These different geographic locations or environments may also have different types of roadway conditions and weather conditions. Driving that is deemed safe or less aggressive under certain traffic environments and/or weather conditions, e.g., driving the speed limit when the weather is dry, may be deemed unsafe in certain different weather conditions, e.g., during a snow event where speed should be reduced for safe travel. As a result, these different roadway conditions and weather conditions may affect and change the different vehicle operating norms. For example, as the travelling autonomous vehicle senses the speed limit for a particular stretch of road, the autonomous vehicle will control operation of the autonomous vehicle so that the speed of the autonomous vehicle does not exceed the posted speed limit. However, further modification to the vehicle operating norms such as vehicle speed may be required if the autonomous vehicle is travelling along a road during a weather event, e.g. rain, snow, wind or in a high traffic stretch of road. Accordingly, there exists a need for a system and method for environmental modification of operating behaviors for an autonomous vehicle that enables the behavior of the autonomous vehicle to better align with vehicle operating norms in a particular geography or environment. These and other needs are met by the exemplary system and method for environmental modification of operating behaviors for an autonomous vehicle discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a system for environmental modification of operating behaviors for an autonomous vehicle is described. The system comprises a database configured to electronically store a plurality of geographic operation profiles and a processing device in communication with the database. The processing device is configured to execute instructions stored in a memory to perform operations. The operations comprise receiving location data for the autonomous vehicle, selecting at least one applicable geographic operation profile from the plurality of geographic operation profiles based on the location data, and modifying an operating protocol for the autonomous vehicle based on the at least one applicable geographic operation profile, wherein the operation of the autonomous vehicle is aligned with the modified operating protocol.

In another aspect, a computer implemented method for environmental modification of operating behaviors for an autonomous vehicle is described. The computer-implemented method comprises electronically storing a plurality of geographic operation profiles in a database and executing instructions stored in a memory with a processing device in communication with the database to perform operations. The operations comprise receiving location data for the autonomous vehicle, selecting at least one applicable geographic operation profile from the plurality of geographic operation profiles based on the location data, and modifying an operating protocol for the autonomous vehicle based on the at least one applicable geographic operation profile, wherein the operation of the autonomous vehicle is aligned with the modified operating protocol.

In yet another aspect, a system for environmental modification of operating behaviors for an autonomous vehicle is described. The system comprises a database configured to electronically store a plurality of geographic operation profiles and a processing device in communication with the database. The processing device is configured to execute instructions stored in a memory to perform operations. The operations comprise selecting an applicable geographic weather operation profile from the plurality of geographic operation profiles based on a current weather condition, selecting an applicable geographic traffic density operation profile from the plurality of geographic operation profiles based on a current traffic condition, selecting an applicable geographic visibility operation profile from the plurality of geographic operation profiles based on a current visibility range, and modifying an operating protocol for the autonomous vehicle based on at least one of the applicable geographic weather operation profile, the applicable geographic traffic density operation profile, and the applicable geographic visibility operation profile, wherein the operation of the autonomous vehicle is aligned with the modified operating protocol.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of the autonomous truck and trailer of FIG. 2.

FIG. 4 is a block diagram of the autonomous truck shown in FIGS. 1-3.

FIG. 5 is a block diagram of an example computing system.

FIG. 6 is a block diagram of an exemplary system for environmental modification of operating behaviors for an autonomous vehicle.

FIG. 7 is a flowchart of an exemplary method for environmental modification of operating behaviors for an autonomous vehicle.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, an exemplary system and method for environmental modification of operating behaviors for an autonomous vehicle provides automatic modification of operating behaviors for the autonomous vehicle. The exemplary system and method ensures that the operation of the autonomous vehicle better conforms to vehicle operating norms associated with a current location of the autonomous vehicle and current environment conditions surrounding the autonomous vehicle.

The exemplary system and method can be used by a processing device for an autonomous vehicle to select relevant operation profiles from a plurality of operation profiles stored by a database in communication with the processing device. The processing device may use inputs from sensors positioned on the vehicles to detect a location of the autonomous vehicle and current environment conditions surrounding the autonomous vehicle, such as traffic density, weather, or the like, during operation of the autonomous vehicle. The processing device may then select the relevant operation profiles from the plurality of operation profiles based on the location of the autonomous vehicle and the current environment conditions surrounding the autonomous vehicle. The system and method are able to allow the processing device to automatically tailor operating behaviors for the autonomous vehicle to better conform to vehicle operating norms associated with the current location of the autonomous vehicle and the current environment conditions surrounding the autonomous vehicle.

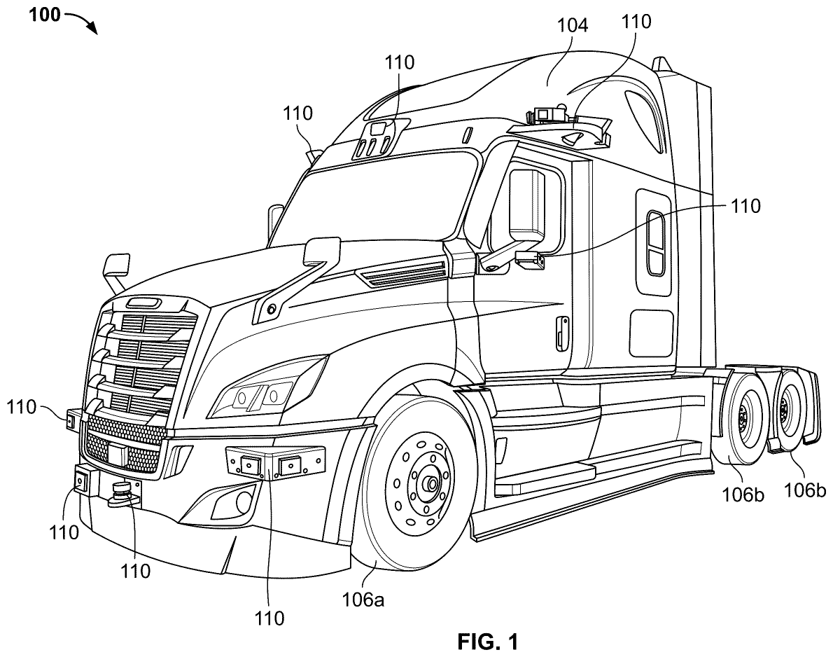

Various embodiments in the present disclosure are described with reference to FIGS. 1-7 below.

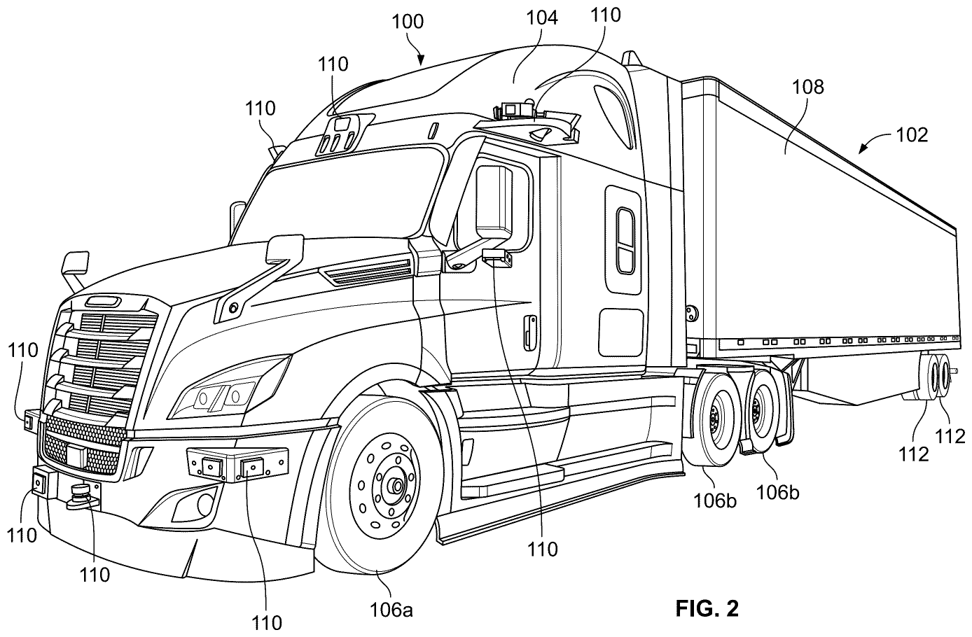

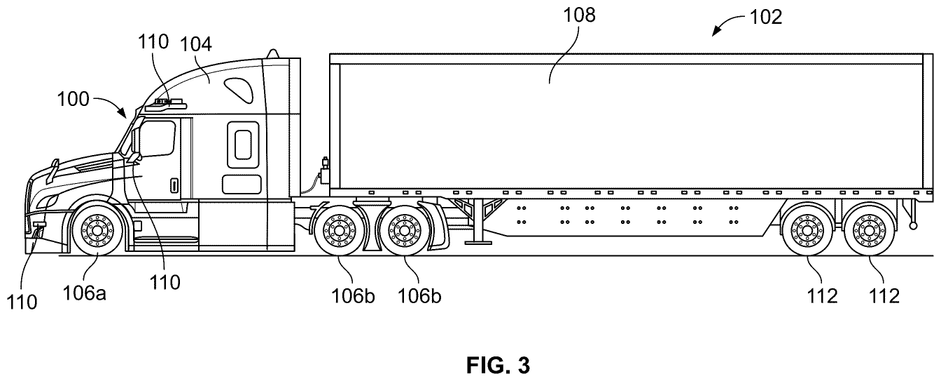

FIG. 1 is a perspective view of a vehicle 100. The vehicle may be a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

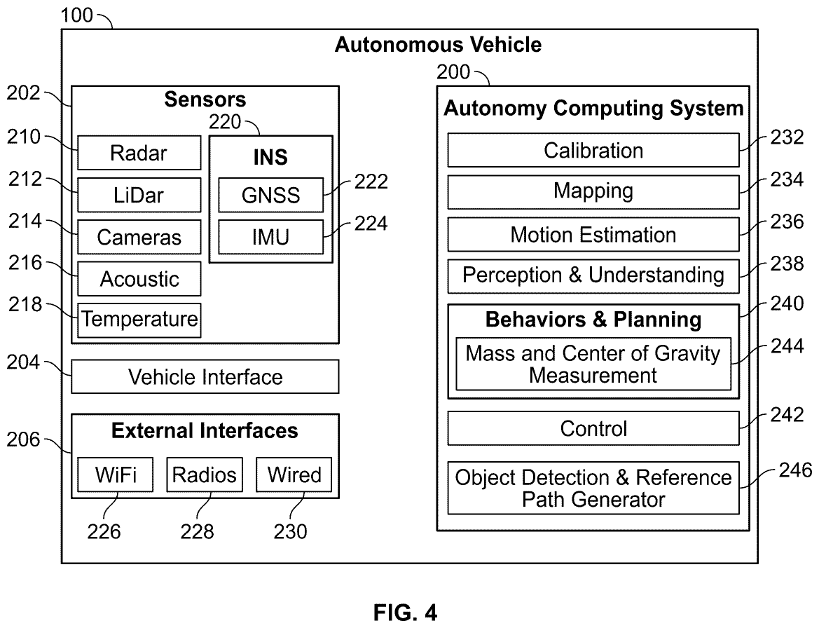

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 208-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field-of-view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors).

External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 230, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 232, a mapping module 234, a motion estimation module 236, a perception and understanding module 238, a behavior and planning module 240, a mass and center of gravity measurement module 244, a control module or controller 242, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

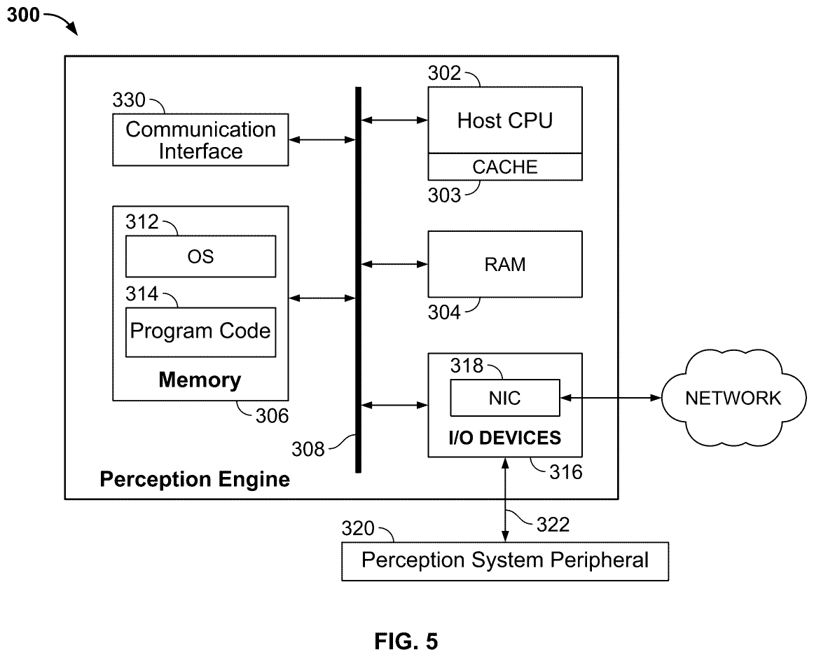

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

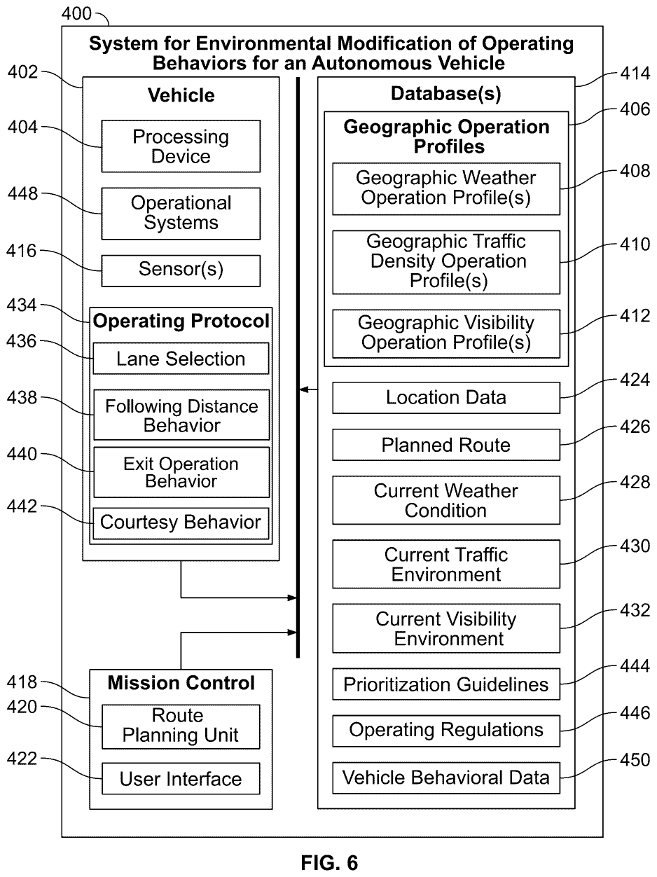

FIG. 6 is a block diagram of an exemplary system 400 for environmental modification of operating behaviors for an autonomous vehicle. The system 400 generally includes one or more vehicles 402 (e.g., autonomous vehicle 100, semi-autonomous vehicle, non-autonomous vehicle, or the like). Each vehicle 402 includes a processing device 404 (e.g., computing system 200, computing system 300, or the like) configured to receive and process data relating to a plurality of geographic operation profiles 406 for modifying operating behaviors for the vehicle 402 while also ensuring the modified operating behaviors conform to operating regulations for the vehicle 402. Each of the plurality of geographic operation profiles 406 may be used by a processing device 404 to modify operating behaviors for the vehicle 402 based on environmental factors and a geographic location of the vehicle 402. For example, each geographic operation profiles 406 may include operating norms for following distances, maximum acceleration rate, lane selection, headlight operation, or the like.

Each of the plurality of geographic operation profiles 406 may be associated with a specified geographic location. For example, the plurality of geographic operation profiles 406 may include at least one geographic operation profile 406 associated with a first geographic location, at least one geographic operation profile 406 associated with a second geographic location, at least one geographic operation profile 406 associated with a third geographic location, etc. The specified geographic locations may be any one of a region, a state, a city, or the like. For example, in some embodiments, the plurality of geographic operation profiles 406 may include at least one geographic operation profile 406 associated with each of New England (e.g., New Hampshire, Connecticut, Massachusetts, etc.), Mid-Atlantic (e.g., New York, New Jersey, etc.), Midwest (e.g., Ohio, Indiana, Illinois, etc.), and any other region. Additionally, or alternatively, the plurality of geographic operation profiles 406 may include at least one geographic operation profile 406 associated with each of Massachusetts, Florida, and any other state and/or Boston, New York City, and any other city. For example, in cases when vehicle operating norms for states differ from regions and/or operating norms for cities differ from states and/or regions, the plurality of geographic operation profiles 406 may include at least one geographic operation profile 406 associated with each of these individual states and cities in addition to geographic operation profiles associated with different regions.

The plurality of geographic operation profiles 406 may include at least one operation profile associated with different environmental factors for each of the specified geographic locations. Environmental factors may include weather, traffic density, visibility, road type (e.g., interstate, local road, mountain road, or the like), road setting (e.g., city, rural, or the like), or the like. For example, the plurality of geographic operation profiles 406 may include geographic weather operation profiles 408, geographic traffic density profiles 410, geographic visibility operation profiles 412, or any other environment factor. Each of the geographic weather operation profiles 408 may be a collection of representative vehicle operating behaviors during specified types of weather for a corresponding geographic location. For example, the geographic weather operation profiles 408 may include collections of representative vehicle operating behaviors during clear weather, light rain, heavy rain, snow, or the like for a corresponding geographic location, such as the specified geographic locations described above.

Each of the geographic traffic density profiles 410 may be a collection of representative vehicle operating behaviors during specified levels of traffic density for a corresponding geographic location. For example, the geographic traffic density profiles 410 may include collections of representative vehicle operating behaviors during different levels of traffic such as high levels of traffic, medium levels of traffic, low levels of traffic, or the like for a corresponding geographic location, such as the specified geographic locations described above.

Each of the geographic visibility operation profiles 412 may be a collection of representative vehicle operating behaviors during specified levels of visibility for a corresponding geographic location. For example, the geographic visibility operation profiles 412 may include collections of representative vehicle operating behaviors during different levels of traffic such as high levels of visibility, medium levels of visibility, low levels of visibility, or the like for a corresponding geographic location, such as the specified geographic locations described above.

The vehicle 402 can include one or more databases 414 (e.g., memory 306) configured to receive and electronically store data. In some embodiments, the database 414 can be stored externally from the vehicle 402 and the vehicle 402 can be in communication with the external database 414 for receiving and/or transmitting data associated with the system 400. The database 414 can electronically store the plurality of geographic operation profiles 406, the geographic weather operation profiles 408, the geographic traffic density profiles 410, the geographic visibility operation profiles 412, or the like, and any other data collected by the at least one sensor 416 (e.g., sensors 110, sensors 202, or the like), such as data described in more detail below. The vehicle 402 and the database 410 can be in communication with mission control 418 for operation of the system 400. Mission control 418 can include a route planning unit 420 and a user interface 422, e.g., a graphical user interface. In some embodiments, the user interface 422 can be at one or both of the vehicle 402 and mission control 418.

In some embodiments, the vehicle 402 includes at least one sensor 416 (e.g., sensors 110, sensors 202, or the like) positioned on the vehicle 402 that is in communication with the processing device 404. Each sensor 416 includes a respective field-of-view that is able to detect an environment surrounding the vehicle 402. The at least one sensor 416 may be configured to collect data about the environment surrounding the vehicle 402, such as location data, weather data, traffic data, individual vehicles data, or the like, and transmit the collected data to the processing device 404.

The processing device 404 receives, as input, location data 424 associated with a vehicle 402. In some embodiments, the location data 424 may include a current location of the vehicle 402. The current location of the vehicle 402 may be determined by, and received from, a sensor of the sensors 416, such as a GNSS receiver 222 or the like. In some embodiments, the location data 424 may include one or more planned routes 426 for the vehicle 402 generated by the route planning unit 420 for use by the vehicle 402 to travel from a starting location to an ending location. The processing device 404 may identify at least one specified geographic location, as described above, associated with the one or more planned routes 426 for the vehicle 402 and use the at least one specified geographic location from the one or more planned routes 426 as the location data 424. For example, the user interface 422 may receive Boston, Massachusetts as a starting location for the vehicle 402 and Columbus, Ohio as the ending location for the vehicle 402 as input and generate one or more planned routes 426 from Boston to Columbus and the processing device 404 may identify Massachusetts, New York, Pennsylvania, and Ohio as the location data 424.

The processing device 404 selects at least one applicable geographic operation profile from the plurality of geographic operation profiles 406 based on the location data 424. Each of the at least one geographic operation profiles is a relevant geographic operation profile that can be used by the processing device 404 to modify operating behaviors for the vehicle 402 to conform to operating norms associated with a specified location. For example, when a current location of the location data 424 associated with the vehicle 402 is Buffalo, New York, the processing device 404 may select operation profiles associated with Buffalo, New York from the plurality of geographic operation profiles 406 for use by the processing device 404 to control operation of the vehicle 402.

In some embodiments, the processing device 404 may determine a current weather condition 428 for the location data 424 associated with the autonomous vehicle 402. The current weather condition 428 may be determined based on an input signal from the at least one sensor 416. For example, the at least one sensor 416 may detect data associated with atmospheric conditions (e.g., temperature, humidity, pressure, precipitation, or the like) and transmit the atmospheric condition data to the processing device 404. The atmospheric condition data may be data associated with a state of the atmosphere surrounding the vehicle 402. The processing device 404 may use the atmospheric data to determine the current weather condition 428.

In some embodiments, selecting the at least one applicable geographic operation profile may comprise selecting an applicable geographic weather operation profile from the at least one geographic weather operation profile 408. The processing device 404 may select the applicable geographic weather operation profile from the at least one geographic weather operation profile 408 based on the current weather condition 428. Each of the at least one geographic weather operation profile 408 can be used by the processing device 404 to modify operating behaviors for the vehicle 402 to operating norms associated with corresponding locations and weather conditions. Referring to the previous example, when the location data 424 associated with the vehicle 402 is Buffalo, New York and the current weather condition in Buffalo, New York is light snow, the processing device 404 may select operation profiles associated with Buffalo from the plurality of geographic operation profiles 406 and an operation profile associated with vehicle operation during light snow from the geographic weather operation profiles 408 associated with Buffalo.

The processing device 404 may determine a current traffic environment 430 for the location data 424 associated with the autonomous vehicle 402. The current traffic environment 430 may be determined based on an input signal from the at least one sensor 416. For example, the at least one sensor 416 may detect data about traffic density within a field of view of each of the at least one sensor 416 and transmit the traffic density data to the processing device 404. The traffic density data may be data associated with a number of vehicles within a specified length of roadway surrounding the vehicle 402. The processing device 404 may use the traffic density data to determine the current traffic environment 430. The current traffic environment 430 may be determined based on the number of vehicles within the field of view of the at least one sensor 416, an average spacing between each of the vehicles within the field of view of the at least one sensor 416, or the like. For example, when the average space between vehicles is less than a first threshold (e.g., 10 feet, 15 feet, or the like), the processing device 404 may determine the vehicle 402 is in a high density traffic environment, when the average space between vehicles is greater than the first threshold and less than a second threshold (e.g., 25 feet, or the like), the processing device 404 may determine the vehicle 402 is in a medium density traffic environment, and when the average space between vehicles is greater than the second threshold, the processing device 404 may determine the vehicle 402 is in a low density traffic environment.

In some embodiments, selecting the at least one applicable geographic operation profile may comprise selecting an applicable geographic traffic density operation profile from the at least one geographic traffic density operation profile 410. The processing device 404 may select the applicable geographic traffic density operation profile from the at least one geographic traffic density operation profile 410 based on the current traffic environment 430. Each of the at least one geographic traffic density operation profile 410 can be used by the processing device 404 to modify operating behaviors for the vehicle 402 to operating norms associated with corresponding locations and traffic conditions. Again returning to the previous example, when the location data 424 associated with the vehicle 402 is Buffalo, New York and the current traffic condition is medium density, the processing device 404 may select operation profiles associated with Buffalo from the plurality of geographic operation profiles 406 and an operation profile associated with vehicle operation within medium density traffic environments from the geographic traffic density operation profiles 410 associated with Buffalo.

The processing device 404 may determine a current visibility environment 432 for the location data 424 associated with the autonomous vehicle 402. The current visibility environment 432 may be determined based on an input signal from the at least one sensor 416. For example, the at least one sensor 416 may detect data about visibility within a field of view of each of the at least one sensor 416 and transmit the visibility data to the processing device 404. The visibility data may be data associated with a maximum distance that the field of view of the at least one sensor 416 extends without obstruction beyond the vehicle 402. The processing device 404 may use the visibility data to determine the current visibility environment 432. The current visibility environment 432 may be determined based on the distance the field of view of the at least one sensor 416 extends beyond the vehicle 402 without obstruction, a percentage of the maximum visibility range of the at least one sensor 416, or the like. For example, when the percentage of the maximum visibility range of the at least one sensor 416 is less than a first threshold (e.g., 25 percent, 30 percent, or the like), the processing device 404 may determine the vehicle 402 is in low visibility environment, when the percentage of the maximum visibility range of the at least one sensor 416 is greater than the first threshold and less than a second threshold (e.g., 60 percent, or the like), the processing device 404 may determine the vehicle 402 is in medium visibility environment, and when the percentage of the maximum visibility range of the at least one sensor 416 is greater than the second threshold, the processing device 404 may determine the vehicle 402 is in a high visibility environment.

In some embodiments, selecting the at least one applicable geographic operation profile may comprise selecting an applicable geographic visibility operation profile from the at least one geographic visibility operation profile 412. The processing device 404 may select the applicable geographic visibility operation profile from the at least one geographic visibility operation profile 412 based on a current visibility environment 432. Each of the geographic visibility operation profiles 412 can be used by the processing device 404 to modify operating behaviors for the vehicle 402 to operating norms associated with corresponding locations and visibility environments. Returning to the previous example, when the location data 424 associated with the vehicle 402 is Buffalo, New York and the current visibility environment is a low visibility environment, the processing device 404 may select operation profiles associated with Buffalo from the plurality of geographic operation profiles 406 and an operation profile associated with vehicle operation within low visibility environments from the geographic visibility operation profiles 412 associated with Buffalo.

The processing device 404 modifies an operating protocol 434 for the vehicle 402 based on the at least one applicable geographic operation profile. The operation of the vehicle 402 is aligned with the modified operating protocol 434. The operating protocol 434 is a collection of guidelines used to control operating behaviors of the vehicle 402. In an exemplary embodiment, modifying operating protocol 434 may include adjusting at least one of a lane selection behavior 436, a following distance behavior 438, an exit operating behavior 440, and a courtesy behavior 442 for the autonomous vehicle. The lane selection behavior 436 may be a preferred lane for use by the vehicle 402. For example, the lane selection behavior 436 may indicate a middle lane of a highway may be the preferred lane for use by the vehicle to avoid merging traffic. The following distance behavior 438 may be a distance the vehicle 402 leaves between the vehicle 402 and a vehicle traveling immediately ahead of the vehicle 402. For example, the following distance behavior 438 may indicate the vehicle 402 should leave 25 feet of space between the vehicle 402 and the vehicle traveling immediately ahead of the vehicle 402.

The exit operating behavior 440 may be steps to be taken by the vehicle 402 to take an exit during travel of the vehicle 402. For example, the exit operating behavior 440 may indicate how early the vehicle 402 should move into a right lane or left lane prior to an exit, a maximum speed the vehicle 402 should travel once in the lane, or the like. The courtesy behavior 442 may be an amount of driving courtesy, e.g. space between vehicles, allowing vehicles to merge, the vehicle 402 should extend to other drivers. For example, when each of the vehicle 402 and a second vehicle are merging, the courtesy behavior 442 may indicate whether the vehicle 402 should allow the second vehicle to merge in front of the vehicle 402. The operating protocol 434 may also include operating behaviors such as controlling of headlights, maximum acceleration rate, or the like.

In some embodiments, modifying the operating protocol 434 for the vehicle 402 may comprise prioritizing the at least one applicable geographic operation profile. The processing device 404 may use prioritization guidelines 444 stored in the database 414 to prioritize the at least one applicable geographic operation profile. The prioritization guidelines 444 may include guidance indicating how the at least one applicable geographic operation profile should be used in modifying the operating protocol 434. For example, when the at least one applicable geographic operation profile includes each of the applicable geographic weather operation profile, the applicable geographic traffic density operation profile, and the applicable geographic visibility operation profile, the processing device 404 may use prioritization guidelines 444 to designate at least one of the applicable geographic weather operation profile, the applicable geographic traffic density operation profile, and the applicable geographic visibility operation profile to be used for modifying the operating protocol 434.

Once the at least one applicable geographic operation profile is prioritized, the processing device 404 may modify the operating protocol 434 based on the prioritization of the at least one applicable geographic operation profile. In some embodiments, the prioritization guidelines 444 may indicate that the applicable geographic operation profile with the safest operating behaviors may be prioritized for use by the processing device 404 in modifying the operating protocol 434 for the autonomous vehicle 402. For example, the applicable geographic weather operation profile may indicate the vehicle 402 should leave a following distance of 30 feet, the applicable geographic traffic density operation profile may indicate the vehicle 402 should leave a following distance of 35 feet, and the applicable geographic visibility operation profile may indicate the vehicle 402 should leave a following distance of 40 feet, the prioritization guidelines 444 may indicate the processing device 404 should prioritize the applicable geographic visibility operation profile and modify a following distance behavior 438 of the operating protocol 434 for the vehicle 402 to 40 feet.

In some embodiments, modifying the operating protocol 434 for the vehicle 402 may comprise assessing the modified operating protocol 434 and operating regulations 446. The processing device 404 may use operating regulations 446 stored in the database 414 to assess the modified operating protocol 434 to ensure the operating protocol 434 complies with the operating regulations 446. The operating regulations 446 may include governmental rules for the operating protocol 434 and/or operation of the vehicle 402. For example, the operating regulation 446 may indicate the vehicle 402 should leave a following distance of a threshold following distance. When the modified operating protocol 434 indicates a specified following distance that is greater than the threshold following distance, the processing device 404 may leave the specified following distance unchanged. When the modified operating protocol 434 indicates a specified following distance that is less than the threshold following distance, the processing device 404 may modify the specified following distance to the threshold following distance.

The modified operating protocol 434 may be input into one or more of the operational systems 448 (e.g., autonomy computing system 200 or the like). The one or more of the operational systems 448 may regulate the operation of the vehicle 402 to modify operating behaviors of the vehicle 402 to allow the behavior of the vehicle 402 to better conform to vehicle operating norms used by drivers for a corresponding location and the environment surrounding the vehicle 402. For example, the one or more of the operational systems 448 may adjust the following distance to a following distance that is typically used by drivers for a corresponding location and a current environment surrounding the vehicle 402.

In some embodiments, the at least one sensor 416 is configured to detect and capture vehicle behavioral data 450 for additional vehicles within the field of view of each of the at least one sensor 416. The processing device 404 may receive the vehicle behavioral data 450 from the at least one sensor 416 and transmit the vehicle behavioral data 450 to the database 414. For example, the at least one sensor 416 can detect examples of spacing between vehicles during travel, lane usage by other vehicles, courtesy extended by other vehicles during merging, or the like as the vehicle 402 travels along routes. The vehicle behavioral data 450 can include visual images and/or video of the vehicle behavior, as well as metadata associated with the vehicle behavior, e.g., location, time, date, weather, or the like. In some embodiments, the vehicle behavioral data 450 may be used to adjust the geographic operation profiles 406.

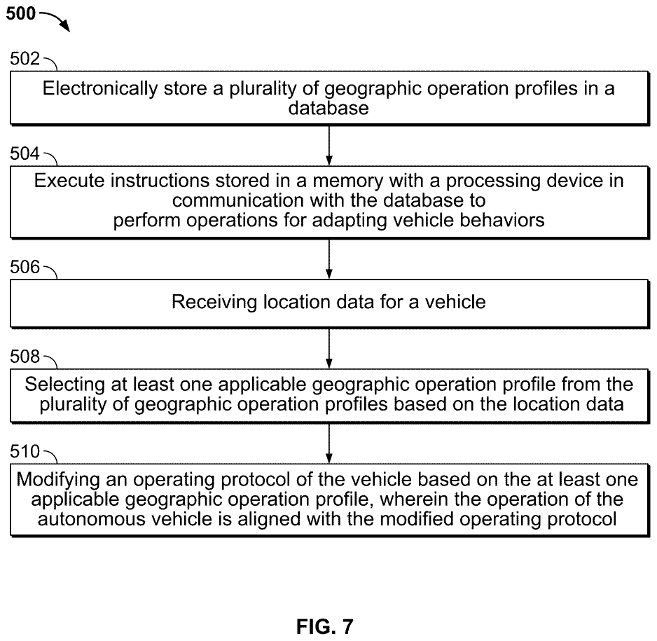

FIG. 7 is a flowchart of a method 500 for environmental modification of operating behaviors for an autonomous vehicle by the exemplary system 400 discussed herein. At 502, electronically storing a plurality of geographic operation profiles in a database. At 504, instructions stored in a memory are executed with a processing device in communication with the data to perform operations for environmental modification of operating behaviors of the autonomous vehicle. At 506, the operations include receiving location data for the autonomous vehicle. At 508, the operations include selecting at least one applicable geographic operation profile from the plurality of geographic operation profiles based on the location data. At 510, the operations include updating an operating protocol for the autonomous vehicle using the at least one applicable geographic operation profile.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for environmental modification of operating behaviors for an autonomous vehicle, the system comprising:
a database configured to electronically store a plurality of geographic operation profiles; and
a processing device in communication with the database, wherein the processing device is configured to execute instructions stored in a memory to perform operations comprising:
receiving location data for the autonomous vehicle;
selecting at least one applicable geographic operation profile from the plurality of geographic operation profiles based on the location data; and
modifying an operating protocol for the autonomous vehicle based on the at least one applicable geographic operation profile, wherein the operation of the autonomous vehicle is aligned with the modified operating protocol.

2. The system of claim 1, wherein the plurality of geographic operation profiles comprise at least one geographic weather operation profile.

3. The system of claim 2, further comprising at least one sensor associated with the autonomous vehicle, each of the sensors having a field of view, and the operations further comprise determining a current weather condition for a current location of the autonomous vehicle from the location data based on an input from the at least one sensor.

4. The system of claim 3, wherein selecting the at least one applicable geographic operation profile comprises selecting an applicable geographic weather operation profile from the at least one geographic weather operation profile based on the current weather condition.

5. The system of claim 3, wherein the plurality of geographic operation profiles further comprise at least one geographic traffic density operation profile.

6. The system of claim 5, wherein the operations further comprise determining a current traffic condition for the current location of the autonomous vehicle based on the input from the at least one sensor.

7. The system of claim 6, wherein selecting the at least one applicable geographic operation profile comprises selecting an applicable geographic traffic density operation profile from the at least one geographic traffic density operation profile based on the current traffic condition.

8. The system of claim 3, wherein the plurality of geographic operation profiles comprise at least one geographic visibility operation profile.

9. The system of claim 8, wherein the operations further comprise determining a current visibility range of the autonomous vehicle based on the input from the at least one sensor.

10. The system of claim 9, wherein selecting the at least one applicable geographic operation profile comprises selecting an applicable geographic visibility operation profile from the at least one geographic visibility operation profile based on the current visibility range.

11. The system of claim 3, wherein the at least one sensor are configured to detect and capture vehicle behavior data for additional vehicles within the field of view of each of the at least one sensor.

12. The system of claim 1, wherein modifying the operating protocol for the autonomous vehicle comprises prioritizing the at least one applicable geographic operation profile and modifying the operating protocol based on the prioritization of the at least one applicable geographic operation profile.

13. The system of claim 1, wherein modifying the operating protocol for the autonomous vehicle comprises adjusting at least one of a lane selection behavior, a following distance behavior, an exit operating behavior, and a courtesy behavior for the autonomous vehicle.

14. A computer-implemented method for environmental modification of operating behaviors for an autonomous vehicle, comprising:
electronically storing a plurality of geographic operation profiles in a database; and
executing instructions stored in a memory with a processing device in communication with the database to perform operations comprising:
receiving location data for the autonomous vehicle;
selecting at least one applicable geographic operation profile from the plurality of geographic operation profiles based on the location data; and
modifying an operating protocol for the autonomous vehicle using the at least one applicable geographic operation profile, wherein the operation of the autonomous vehicle is aligned with the modified operating protocol.

15. The computer-implemented method of claim 14, wherein the plurality of geographic operation profiles comprise at least one geographic weather operation profile.

16. The computer-implemented method of claim 14, wherein the plurality of geographic operation profiles comprise at least one geographic traffic density operation profile.

17. The computer-implemented method of claim 14, wherein the plurality of geographic operation profiles comprise at least one geographic visibility operation profile.

18. The computer-implemented method of claim 14, wherein modifying the operating protocol for the autonomous vehicle comprises prioritizing the at least one applicable geographic operation profile and modifying the operating protocol based on the prioritization of the at least one applicable geographic operation profile.

19. A system for environmental modification of operating behaviors for an autonomous vehicle, the system comprising:
a database configured to electronically store a plurality of geographic operation profiles; and
a processing device in communication with the database, wherein the processing device is configured to execute instructions stored in a memory to perform operations comprising:
selecting an applicable geographic weather operation profile from the plurality of geographic operation profiles based on a current weather condition;
selecting an applicable geographic traffic density operation profile from the plurality of geographic operation profiles based on a current traffic condition;
selecting an applicable geographic visibility operation profile from the plurality of geographic operation profiles based on a current visibility range; and
modifying an operating protocol for the autonomous vehicle based on at least one of the applicable geographic weather operation profile, the applicable geographic traffic density operation profile, and the applicable geographic visibility operation profile, wherein the operation of the autonomous vehicle is aligned with the modified operating protocol.

20. The system of claim 19, wherein modifying the operating protocol comprises modifying the operating protocol based on each of the applicable geographic weather operation profile, the applicable geographic traffic density operation profile, and the applicable geographic visibility operation profile.
